(19) United States
(12) Patent Application Publication
(10) Pub. No.: US 2021/0011962 A1
(43) Pub. Date: Jan. 14, 2021

(54) System and Method for Managing Database Services for Pet Information

(71) Applicant: Delmira Alexandra Albright, Vista, CA (US)

(72) Inventor: Delmira Alexandra Albright, Vista, CA (US)

(21) Appl. No.: 16/927,981

(22) Filed: Jul. 13, 2020

Related U.S. Application Data
(60) Provisional application No. 62/873,110, filed on Jul. 11, 2019.

(51) Int. Cl. G06F 16/9535; G06F 16/901; G06F 16/958

(52) U.S. Cl. CPC G06F 16/9535; G06F 16/958; G06F 16/9017

(57) ABSTRACT

A method for managing database services for pet information provides a system for collecting and storing information about the pet or pets of the user, including medical history, proof of ownership, and more. The system further enables users to connect to each other and to necessary resources based on the user's location. The system intends to provide users with a social media application in the form of a mobile application or website. The system further intends to provide users with the ability to store and organize a plethora of documents and pet information within an electronic database. Users are provided with a social media application that provides social media capabilities including, but not limited to, online communication amongst users of the present invention, sharing of social events, and sharing of relevant information and/or documents to users and non-users of the application. Furthermore, users may search for nearby veterinary facilities.

The current application claims a priority to the U.S. Provisional Patent application Ser. No. 62/873,110 filed on Jul. 11, 2019. The current application is filed on Jul. 13, 2020 while Jul. 11, 2020 was on a weekend.

### FIELD OF THE INVENTION

The present invention generally relates to pet management. More specifically, the present invention is a method for managing database services for pet information relating to a system for utilizing internet-enabled devices and remote servers in order to collect and store house pet information, as well as to facilitate communication between users and various pet services.

### BACKGROUND OF THE INVENTION

The long history of the domestication of the wolf and the resultant friendly dogs many people enjoy as pets today is a testament to the value that humans place on companionship. Pet owners of all kinds have the opportunity to practice the responsibility of caring for a life and to reap the simple rewards of caring for an animal. Concurrently, there has been an increase in the prevalence and use of social media applications in the daily lives of many. Many aspects of life are centered around such applications, which range from communicating with other people to electronically storing and organizing documents, and much more. For instance, there are social media applications that assist in the collection of medical documents for individuals into a single, easily accessible database. There are some social media applications that can connect various individuals globally around a specific interest or topic, such as pets or animals. However, there has not been a social media application that combines an online database system containing medical documents for pets with social media communication capabilities like online chatting and/or post sharing of events and relevant information all pertaining to pets and animals.

An objective of the present invention is to provide users with a device that can be a system and method for managing database services for pet information. The method for managing database services for pet information intends to provide users with a social media application in the form of a mobile application or website. The present invention intends to provide users with the ability to store and organize a plethora of documents and pet information within an electronic database. Users are provided with a social media application that provides social media capabilities including, but not limited to, online communication amongst users of the present invention, sharing of social events, and sharing of relevant information and/or documents to users and non-users of the application. Furthermore, the present invention intends to provide users with a social media application that will allow users to search for nearby veterinary facilities.

### BRIEF DESCRIPTION OF THE DRAWINGS

FIG. 1 is a block diagram illustrating the system of the present invention.

FIG. 2 is a flowchart illustrating an overall process for the method of the present invention.

FIG. 3 is a flowchart illustrating the subprocess of entering new pet-related entries.

FIG. 4 is a flowchart illustrating the subprocess of searching for vendors.

FIG. 5 is a flowchart illustrating the subprocess of managing a calendar.

FIG. 6 is a flowchart illustrating the subprocess of entering new calendar events.

FIG. 7 is a flowchart illustrating the subprocess of sending messages.

FIG. 8 is a flowchart illustrating the subprocess of replying to received messages.

FIG. 9 is a flowchart illustrating the subprocess of searching for nearby users.

FIG. 10 is a flowchart illustrating the subprocess of navigating a discussion forum.

FIG. 11 is a flowchart illustrating the subprocess of contributing to a discussion forum.

### DETAILED DESCRIPTION OF THE INVENTION

All illustrations of the drawings are for the purpose of describing selected versions of the present invention and are not intended to limit the scope of the present invention.

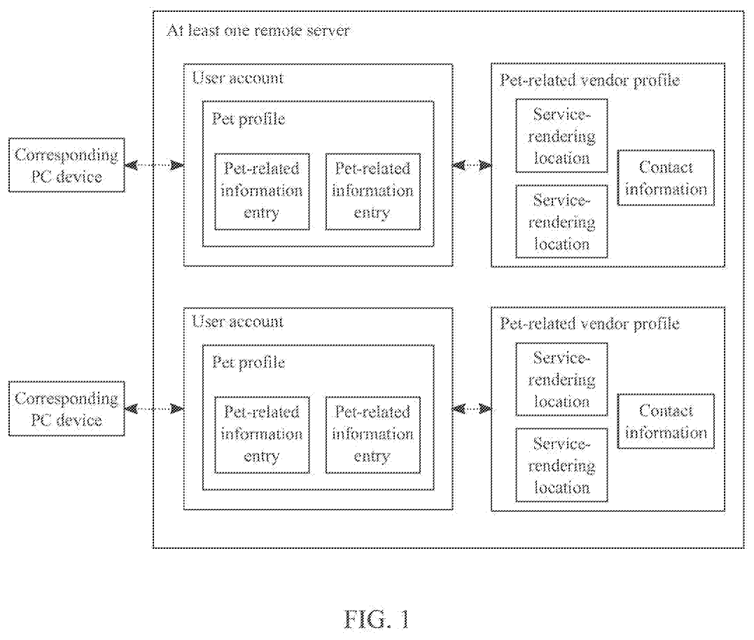

The present invention is a method for managing database services for pet information that provides a system for collecting and storing information about the pet or pets of the user, including medical history, proof of ownership, and more. The present invention further enables users to connect to each other and to locate and connect to necessary local resources. The system of the present invention, as represented in FIG. 1, includes a plurality of user accounts managed by at least one remote server, wherein each user account is associated with a corresponding PC device, and wherein each user account includes at least one pet profile, and wherein the pet profile includes a plurality of pet-related information entries (Step A). The plurality of user accounts relates to a set of information, including, but not limited to, demographics, contact information, username, password, and more that can be used to connect an individual user with a specific user account. The at least one remote server relates to a network of computing devices connected over the Internet that are capable of collecting data, storing data, analyzing user inputs, and responding with appropriate outputs, thereby allowing each user of the plurality of user accounts to save information and connect to other user accounts. The corresponding PC device may be any of computers, smartphones, laptops, or a variety of other devices capable of allowing a user to communicate with the at least one remote server. The at least one pet profile relates to the set of information associated with each pet owned or cared for by the user account. The plurality of pet-related information entries denotes different information categories of the pet. The plurality of pet-related information entries may include, but is not limited to, information regarding the pet's name, age, breed, weight, height, color, identifying features, medical history, medications, images, videos, audio clips, description, demeanor, primary veterinarian information, walking schedule, feeding schedule, preferred food brand or type, or a variety of other items of information that may be useful in identifying or managing the associated pet. There is no limit to the amount of available storage for pet-related information.

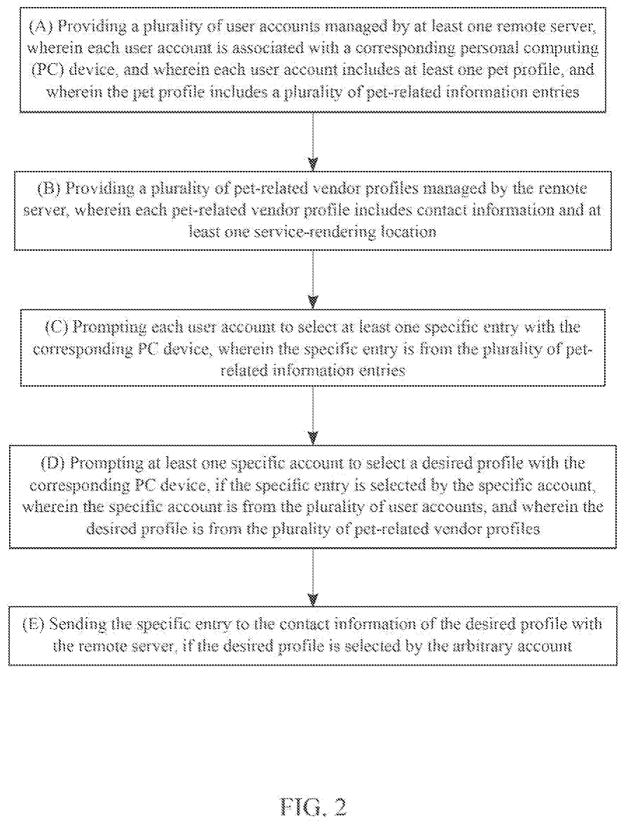

Furthermore, a plurality of pet-related vendor profiles managed by the remote server is provided, wherein each pet-related vendor profile includes contact information and at least one service-rendering location (Step B), as represented in FIG. 2. The plurality of pet-related vendor profiles relates to a set of services and product distributers associated with a given area. The contact information denotes the name, phone number or phone numbers, email addresses, and other such information necessary to send and receive messages. The at least one service-rendering location relates to the physical location or area in which the specific pet-related vendor profile operates.

The arrangement of features in the overall process of the present invention enables the user to communicate with appropriate pet-related parties as desired. Each user account is prompted to select at least one specific entry with the corresponding PC device, wherein the specific entry is from the plurality of pet-related information entries (Step C), as represented in FIG. 2. The specific entry may be as simple as name and breed information, or as complex as necessary documentation for a veterinarian, pet walker, house-sitter, or other profession which requires up-to-date pet information. The at least one specific account is next prompted to select a desired profile with the corresponding PC device, if the specific entry is selected by the specific account, wherein the specific account is from the plurality of user accounts, and wherein the desired profile is from the plurality of pet-related vendor profiles (Step D). In this way, each user account may determine an appropriate service, such as a veterinarian or a toy vendor, for subsequent sending of relevant information. Finally, the specific entry is sent to the contact information of the desired profile with the remote server, if the desired profiled is selected by the arbitrary account (Step E). Thus, the relevant pet-related vendor profile receives the information necessary to begin carrying out a task or providing a service or product.

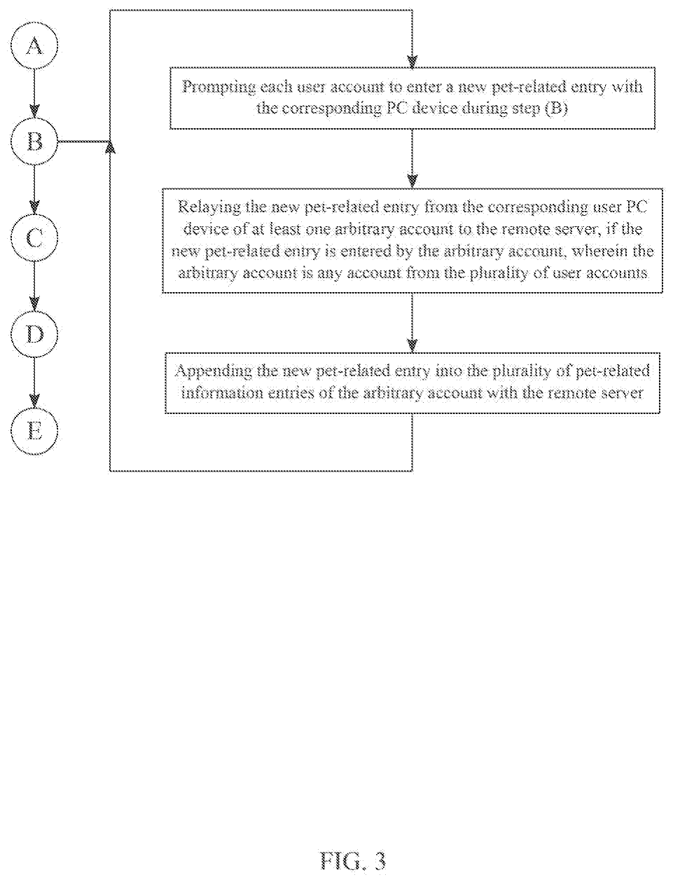

The user requires a standardized process by which to append new information into each pet profile. To achieve this, each user account may be prompted to enter a new pet-related entry with the corresponding PC device, as represented in FIG. 3. The new pet-related entry may relate to new or updated medical information, new pictures, updated description, or a variety of other data relevant to the pet profile. Next, the new pet-related entry is relayed from the corresponding user PC device of at least one arbitrary account to the remote server, if the new pet-related entry is entered by the arbitrary account, wherein the arbitrary account is any account from the plurality of user accounts. The remote server may process the new pet-related entry, organize the data into appropriate files or formats, store the data in a database, and apply any necessary logic to convert the new pet-related entry into an appropriate form. Finally, the new pet-related entry is appended into the plurality of pet-related information entries of the arbitrary account with the remote server. Thus, the plurality of pet-related information entries may be updated by the user account.

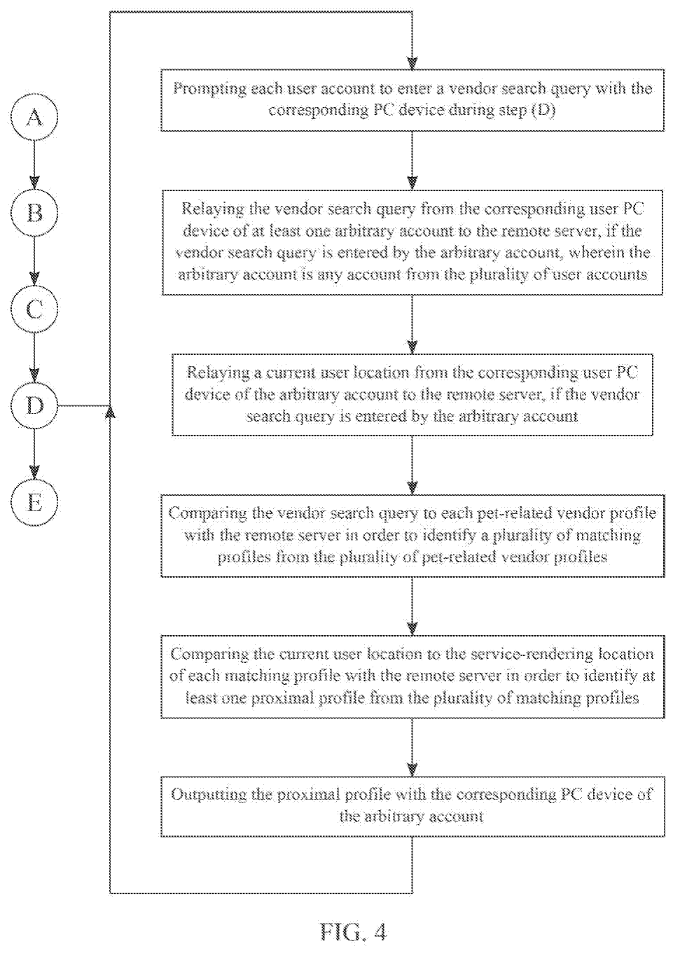

There are many occasions in which a user account must seek resources, facilities, or trained professionals for their pets. To accommodate for this need, each user account may be prompted to enter a vendor search query with the corresponding PC device, as represented in FIG. 4. The vendor search query may be conducted by vendor name, animal specialties, available inventory, or a variety of other criteria. Next, the vendor search query is relayed from the corresponding user PC device of at least one arbitrary account to the remote server, if the vendor search query is entered by the arbitrary account, wherein the arbitrary account is any account from the plurality of user accounts. In this way, the remote server is able to store, manipulate, and distribute information as necessary for subsequent transmission. A current user location is then relayed from the corresponding user PC device of the arbitrary account to the remote server, if the vendor search query is entered by the arbitrary account. The current user location may be subsequently utilized to determine which vendors are within a reasonable distance of the current user location, thus ensuring convenience to user accounts that are traveling with their pets. The vendor search query is compared to each pet-related vendor profile with the remote server in order to identify a plurality of matching profiles from the plurality of pet-related vendor profiles. The plurality of matching profiles is related to a series of businesses containing the desired products or services as indicated by the vendor search query. This comparison enables the remote server to filter through options and identify profiles that may provide the desired services or products. The current user location is then compared to the service-rendering location of each matching profile with the remote server in order to identify at least one proximal profile from the plurality of matching profiles. In this way, the remote server may determine a most-convenient or closest profile from each matching profile. Finally, the proximal profile is outputted with the corresponding PC device of the arbitrary account. Thus, the user account may view appropriately filtered search responses from the user PC device.

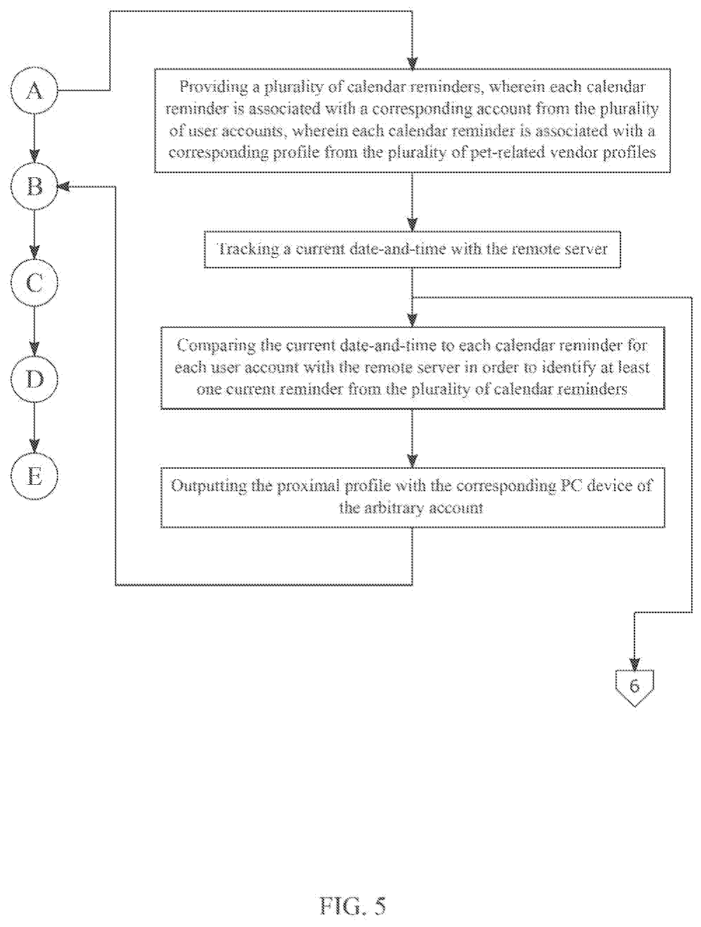

Many services necessary for pets involve planning and scheduling in advance. To allow for this, a plurality of calendar reminders may be provided, wherein each calendar reminder is associated with a corresponding account from the plurality of user accounts, wherein each calendar reminder is associated with a corresponding profile from the plurality of pet-related vendor profiles, as represented in FIG. 5. The plurality of calendar reminders relates to a set of notifications coordinated for a specific time and date. A current date-and-time is tracked with the remote server. This may be accomplished using external resources, including various time-management tools and interfaces that may be built into different production technologies. The current date-and-time is then compared to each calendar reminder for each user account with the remote server in order to identify at least one current reminder from the plurality of calendar reminders. This current reminder relates to an event that is scheduled for that day and time, thus suggesting the importance of visually notifying the user of a scheduled appointment. Next, the current reminder for the corresponding profile is outputted with the corresponding PC device of the corresponding user account. In this way, the user account may view the reminder as a means of facilitating preparation for an appointment with a pet care provider.

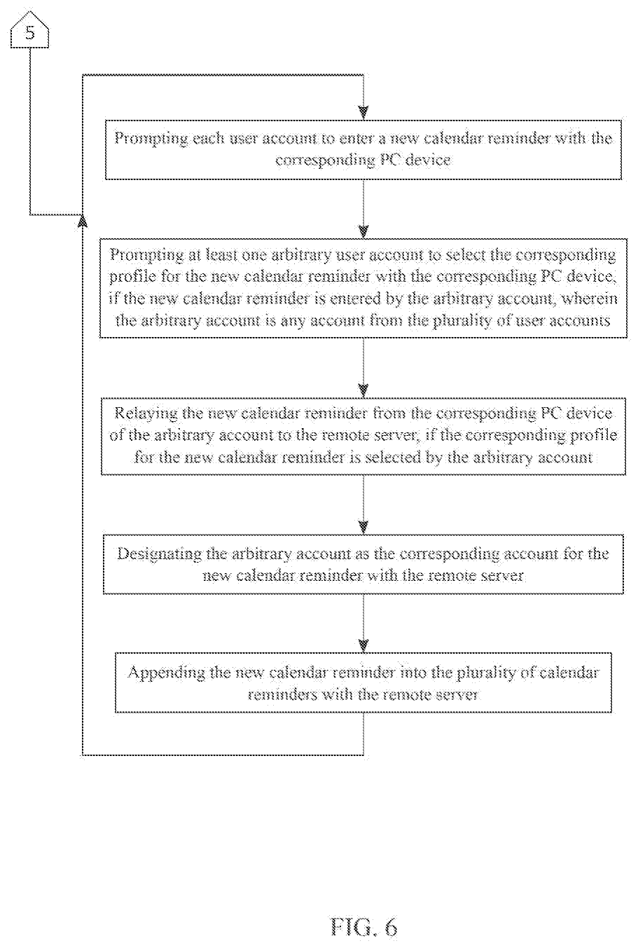

The user may further desire to add reminders or other notes to the plurality of calendar reminders. To achieve this, each user account may be prompted to enter a new calendar reminder with the corresponding PC device, as represented in FIG. 6. The new calendar reminder may require information including, but not limited to, time, date, title, description, images, notes, and more. At least one arbitrary account is prompted to select the corresponding profile for the new calendar reminder with the corresponding PC device, if the new calendar reminder is entered by the arbitrary account, wherein the arbitrary account is any account from the plurality of user accounts. In this way, the user account may attempt to synchronize the new calendar reminder with a given vendor, thus ensuring each involved party is prepared for the planned event. The new calendar reminder is relayed from the corresponding PC device of the arbitrary account to the remote server, if the corresponding profile for the new calendar reminder is selected by the arbitrary account. The remote server may then store and manipulate data as necessary to prepare to send the new calendar reminder onward. The arbitrary account is then designated as the corresponding account for the new calendar reminder with the remote server. In this way, the arbitrary account is assigned to receive an alert or other such notification and may further be given managerial privileges in organizing the new calendar reminder. Finally, the new calendar reminder is appended into the plurality of calendar reminders with the remote server. This arrangement allows the corresponding account to view and to be notified by the new calendar reminder as necessary.

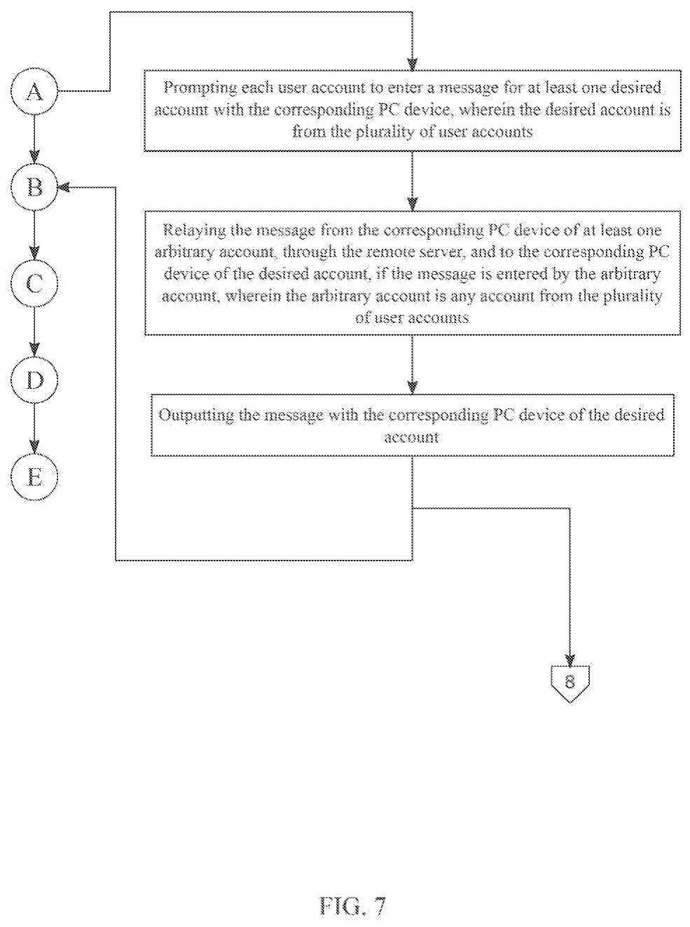

It may be desirable for a user account to connect with local pet owners in an attempt to exchange information, plan events, or otherwise socialize. To enable this, each user account may be prompted to enter a message for at least one desired account with the corresponding PC device, wherein the desired account is from the plurality of user accounts, as represented in FIG. 7. The message may include text, images, voice memos, videos, hyperlinks, or other types of media commonly used in text-based communication. Next, the message is relayed from the corresponding PC device of at least one arbitrary account, through the remote server, and to the corresponding PC device of the desired account, if the message is entered by the arbitrary account, wherein the arbitrary account is any account from the plurality of user accounts. Appropriate data may be transmitted to the appropriate parties using a variety of existing or developing secure methodologies. The message is then outputted with the corresponding PC device of the desired account. In this way, the desired account may, in accordance with customizable security and messaging preferences, receive information from the user account.

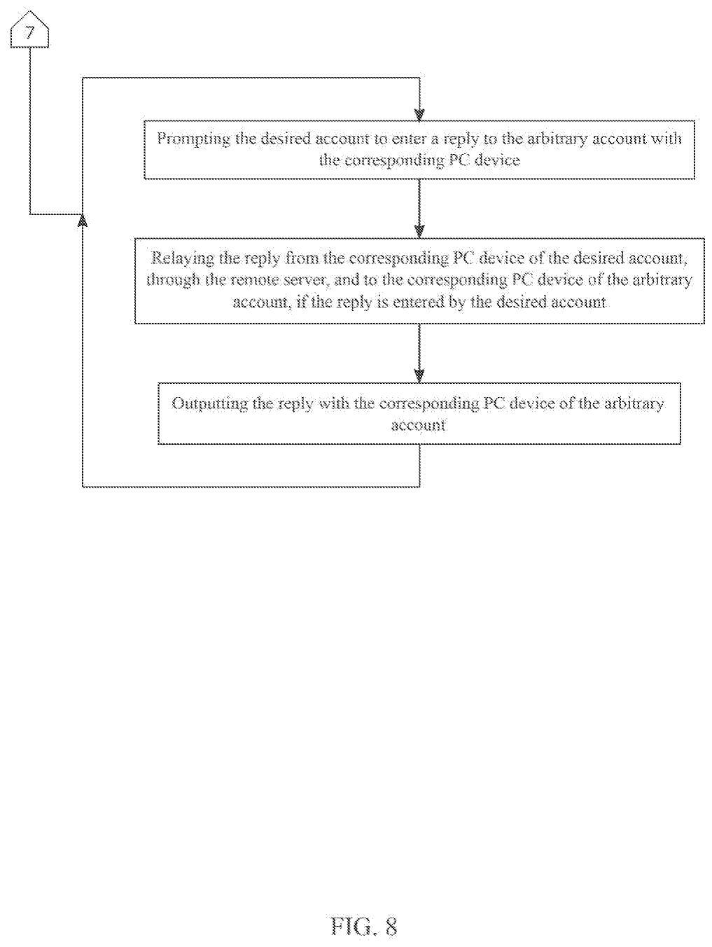

It may be subsequently desirable for the desired account to respond to a received message from the arbitrary account. To allow for this, the desired account may be prompted to enter a reply to the arbitrary account with the corresponding PC device, as represented in FIG. 8. As with the message, the reply may include text, images, voice memos, videos, hyperlinks, or other types of media commonly used in text-based communication. The reply is then relayed from the corresponding PC device of the desired account, through the remote server, and to the corresponding PC device of the arbitrary account, if the reply is entered by the desired account. Appropriate data may be transmitted to the appropriate parties using a variety of existing or developing secure methodologies. The reply is outputted with the corresponding PC device of the arbitrary account. This arrangement allows the arbitrary account to view a reply from the desired account.

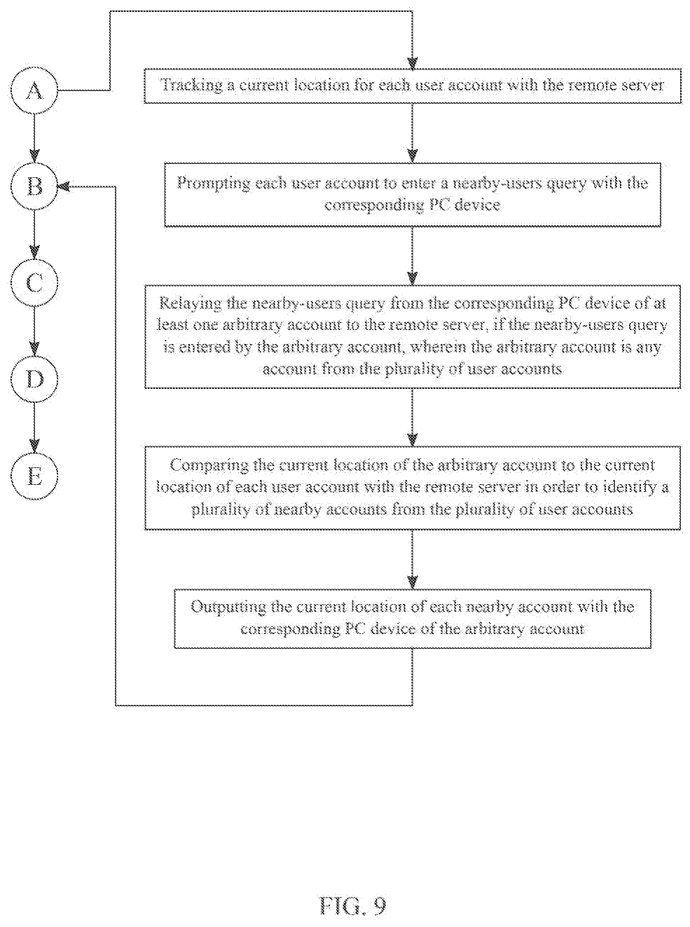

In many cases, a user may wish to locate nearby users in order to coordinate visits to a dog park or pet event. To enable this, a current location may be tracked for each user account with the remote server, as represented in FIG. 9. This is necessary in order to determine proximity to other user accounts. Each user account is prompted to enter a nearby-users query with the corresponding PC device. This nearby-users query may include specifications such as distance, pet breed, pet name, or more. The nearby-users query is next relayed from the corresponding PC device of at least one arbitrary account to the remote server, if the nearby-users query is entered by the arbitrary account, wherein the arbitrary account is any account from the plurality of user accounts. In this way, the remote server may perform necessary storage and data manipulation operations in order to generate an appropriate response. The current location of the arbitrary account is compared to the current location of each user account with the remote server in order to identify a plurality of nearby accounts from the plurality of user accounts. Thus, the remote server uses the provided location data only to enable comparisons between users. Finally, the current location of each nearby account is outputted with the corresponding PC device of the arbitrary account. This arrangement enables each user account to determine the presence of other pet owners in proximity.

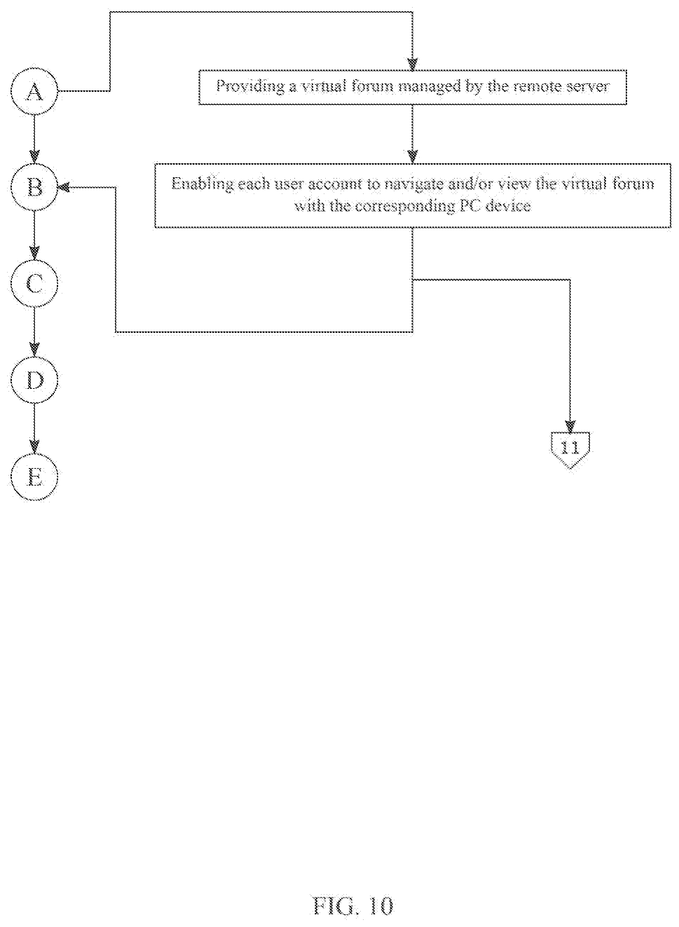

Pet owners may have questions about their pets that owners of similar pets may have answers to. To facilitate this discussion, a virtual forum may be provided and managed by the remote server, as represented in FIG. 10. The virtual forum relates to a searchable long-term storage system that enables users to discover answers and relevant discussions around their common or uncommon questions. Each user account is enabled to navigate and/or view the virtual forum with the corresponding PC device. Thus, each user account may find information specific to their pet breed or type based on previous discussions.

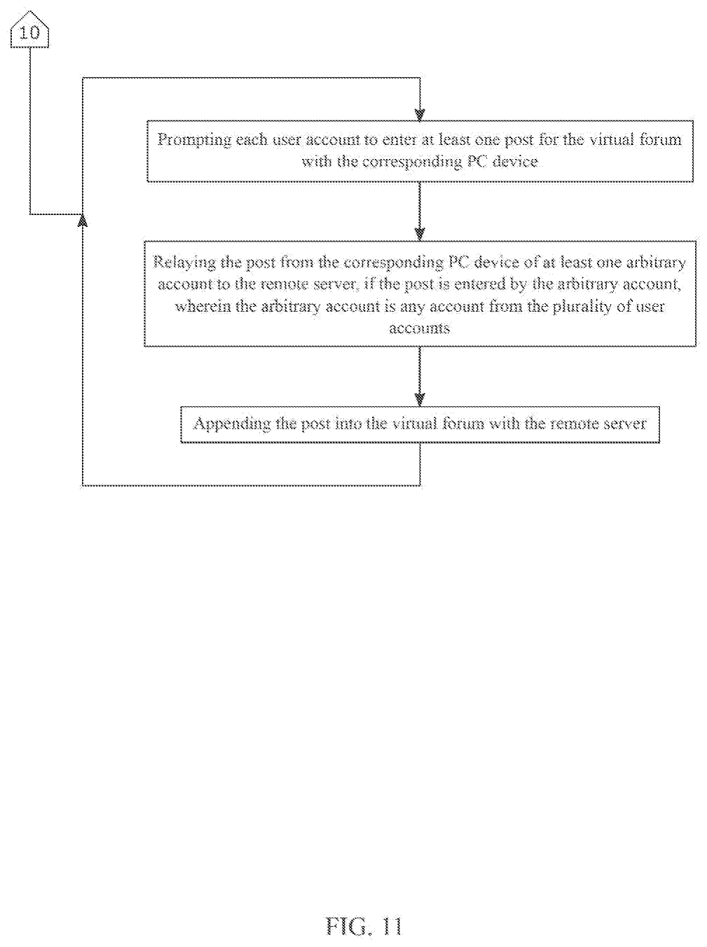

A user account may wish to contribute information to the virtual forum. To enable this, each user account is prompted to enter at least one post for the virtual forum with the corresponding PC device, as represented in FIG. 11. The at least one post may include information such as text, links, images, videos, audio files, and more as relevant and necessary. The post is then relayed from the corresponding PC device of at least one arbitrary account to the remote server, if the post is entered by the arbitrary account, wherein the arbitrary account is any account from the plurality of user accounts. The remote server may therefore store and analyze the provided post data, preparing the post for presentation in the virtual forum. Finally, the post is appended into the virtual forum with the remote server. This arrangement allows other user accounts to search for relevant posts in the virtual forum as desired.

Although the invention has been explained in relation to its preferred embodiment, it is to be understood that many other possible modifications and variations can be made without departing from the spirit and scope of the invention as hereinafter claimed.

What is claimed is:

1. A method of managing database services for pet information, the method comprises the steps of:
(A) providing a plurality of user accounts managed by at least one remote server, wherein each user account is associated with a corresponding PC device, and wherein each user account includes at least one pet profile, and wherein the pet profile includes a plurality of pet-related information entries;
(B) providing a plurality of pet-related vendor profiles managed by the remote server, wherein each pet-related vendor profile includes contact information and at least one service-rendering location;
(C) prompting each user account to select at least one specific entry with the corresponding PC device, wherein the specific entry is from the plurality of pet-related information entries;
(D) prompting at least one specific account to select a desired profile with the corresponding PC device, if the specific entry is selected by the specific account, wherein the specific account is from the plurality of user accounts, and wherein the desired profile is from the plurality of pet-related vendor profiles; and
(E) sending the specific entry to the contact information of the desired profile with the remote server, if the desired profiled is selected by the arbitrary account.

2. The method of managing database services for pet information, the method as claimed in claim 1 comprises the steps of:
prompting each user account to enter a new pet-related entry with the corresponding PC device;
relaying the new pet-related entry from the corresponding user PC device of at least one arbitrary account to the remote server, if the new pet-related entry is entered by the arbitrary account, wherein the arbitrary account is any account from the plurality of user accounts; and
appending the new pet-related entry into the plurality of pet-related information entries of the arbitrary account with the remote server.

3. The method of managing database services for pet information, the method as claimed in claim 1 comprises the steps of:
prompting each user account to enter a vendor search query with the corresponding PC device;
relaying the vendor search query from the corresponding user PC device of at least one arbitrary account to the remote server, if the vendor search query is entered by the arbitrary account, wherein the arbitrary account is any account from the plurality of user accounts;
relaying a current user location from the corresponding user PC device of the arbitrary account to the remote server, if the vendor search query is entered by the arbitrary account;
comparing the vendor search query to each pet-related vendor profile with the remote server in order to identify a plurality of matching profiles from the plurality of pet-related vendor profiles;
comparing the current user location to the service-rendering location of each matching profile with the remote server in order to identify at least one proximal profile from the plurality of matching profiles; and
outputting the proximal profile with the corresponding PC device of the arbitrary account.

4. The method of managing database services for pet information, the method as claimed in claim 1 comprises the steps of:
providing a plurality of calendar reminders, wherein each calendar reminder is associated with a corresponding account from the plurality of user accounts, wherein each calendar reminder is associated with a corresponding profile from the plurality of pet-related vendor profiles;
tracking a current date-and-time with the remote server;
comparing the current date-and-time to each calendar reminder for each user account with the remote server in order to identify at least one current reminder from the plurality of calendar reminders; and
outputting the current reminder for the corresponding profile with the corresponding PC device of the corresponding user account.

5. The method of managing database services for pet information, the method as claimed in claim 4 comprises the steps of:
prompting each user account to enter a new calendar reminder with the corresponding PC device;
prompting at least one arbitrary account to select the corresponding profile for the new calendar reminder with the corresponding PC device, if the new calendar reminder is entered by the arbitrary account, wherein the arbitrary account is any account from the plurality of user accounts;
relaying the new calendar reminder from the corresponding PC device of the arbitrary account to the remote server, if the corresponding profile for the new calendar reminder is selected by the arbitrary account;
designating the arbitrary account as the corresponding account for the new calendar reminder with the remote server; and
appending the new calendar reminder into the plurality of calendar reminders with the remote server.

6. The method of managing database services for pet information, the method as claimed in claim 1 comprises the steps of:
prompting each user account to enter a message for at least one desired account with the corresponding PC device, wherein the desired account is from the plurality of user accounts;
relaying the message from the corresponding PC device of at least one arbitrary account, through the remote server, and to the corresponding PC device of the desired account, if the message is entered by the arbitrary account, wherein the arbitrary account is any account from the plurality of user accounts; and
outputting the message with the corresponding PC device of the desired account.

7. The method of managing database services for pet information, the method as claimed in claim 6 comprises the steps of:
prompting the desired account to enter a reply to the arbitrary account with the corresponding PC device;
relaying the reply from the corresponding PC device of the desired account, through the remote server, and to the corresponding PC device of the arbitrary account, if the reply is entered by the desired account; and
outputting the reply with the corresponding PC device of the arbitrary account.

8. The method of managing database services for pet information, the method as claimed in claim 1 comprises the steps of:
tracking a current location for each user account with the remote server;
prompting each user account to enter a nearby-users query with the corresponding PC device;
relaying the nearby-users query from the corresponding PC device of at least one arbitrary account to the remote server, if the nearby-users query is entered by the arbitrary account, wherein the arbitrary account is any account from the plurality of user accounts;
comparing the current location of the arbitrary account to the current location of each user account with the remote server in order to identify a plurality of nearby accounts from the plurality of user accounts; and
outputting the current location of each nearby account with the corresponding PC device of the arbitrary account.

9. The method of managing database services for pet information, the method as claimed in claim 1 comprises the steps of:
providing a virtual forum managed by the remote server; and
enabling each user account to navigate and/or view the virtual forum with the corresponding PC device.

10. The method of managing database services for pet information, the method as claimed in claim 9 comprises the steps of:
prompting each user account to enter at least one post for the virtual forum with the corresponding PC device;
relaying the post from the corresponding PC device of at least one arbitrary account to the remote server, if the post is entered by the arbitrary account, wherein the arbitrary account is any account from the plurality of user accounts; and
appending the post into the virtual forum with the remote server.
